(19) United States
(12) Patent Application Publication
(10) Pub. No.: US 2017/0197166 A1
(43) Pub. Date: Jul. 13, 2017

(54) DUST COLLECTOR BAG FILTER CLEANING SYSTEM HAVING TWO CONTROL VALVES SEPARATED FROM EACH OTHER AND TWO COMPRESSED AIR PIPES SEPARATED FROM EACH OTHER

(71) Applicant: Kwang-Sup CHO, Seongnam-si (KR)

(72) Inventor: Kwang-Sup CHO, Seongnam-si (KR)

(21) Appl. No.: 15/327,654

(22) PCT Filed: Jan. 7, 2015
(86) PCT No.: PCT/KR2015/000138

§ 371 Date: Jan. 19, 2017

(30) Foreign Application Priority Data
Jul. 25, 2014 (KR) 10-2014-0094621

(51) Int. Cl. B01D 46/04; B01D 46/00; B01D 46/44

(52) U.S. Cl. CPC B01D 46/04; B01D 46/44; B01D 46/0068

(57) ABSTRACT

The present invention relates to a dust collector bag filter dust removal system that independently supplies and sprays compressed air to an air amplifier, an inside of which is partitioned, by using two control valves separated from each other and two compressed air pipes separated from each other, and thus has a stronger dust removing force than that of a conventional compressed air spraying apparatus.

### TECHNICAL FIELD

The present invention relates to a dust collector bag filter dust removal system that independently supplies and sprays compressed air to an air amplifier, an inside of which is partitioned, by using two control valves separated from each other and two compressed air pipes separated from each other, and thus has a stronger dust removing force than that of a conventional compressed air spraying apparatus.

The present application claims the benefit of the filing date of Korean Patent Application No. 10-2014-0094621 filed on Jul. 25, 2014, the entire contents of which are incorporated herein by reference.

### BACKGROUND ART

Generally, dust collectors are essentially used to prevent environmental pollution caused by exhaust gases, fine dusts, and industrial wastes discharged during manufacturing or processing in cement, textile or chemical manufacturing factories or metal processing factories.

A dust collector, which collects floating dust and purifies the dust into clean air to be discharged outside, includes a bag filter. When a dust layer on a surface of the bag filter is too thick, pressure loss is increased and thus dusting is required after use to some degree.

As a generally used dust collector bag filter dust removal method, an air pulse jet method is used in which, by instantaneously spraying powerful compressed air, the directly sprayed compressed air and amplified air drawn from the surroundings due to high-speed spraying are rapidly introduced into a bag filter and thus the bag filter is inflated, thereby removing dusts attached to the surface of the bag filter.

As the related art to which such air pulse jet method is applied, Korean Patent Application Publication No. 2001-0033657 (published on Apr. 25, 2001) discloses a Coand\check{a} injector and a compressed gas line for connecting the injector.

The above-described invention relates to an injector coupled to maximize a Coand\check{a} effect and is characterized in that the injector includes an inlet for a medium to be introduced, a pre-chamber including one or more inlets for a pressuring medium supplied via a compressed gas line and a nozzle slot having an annular shape, and an outlet for the medium to be introduced and the pressurizing medium.

Also, Korean Patent Application Publication No. 10-2009-0102977 (published on Oct. 1, 2009) discloses a filter cleaning air injection apparatus for pulse-jet type bag filters characterized in that a spraying device that sprays dusting air to a bag filter is installed at an upper portion of a supply pipe 12 so that the dusting air can be sprayed to the bag filter installed on a lower side of the supply pipe 12 while flowing along an outer circumferential surface of the supply pipe 12 (See FIG. 1).

However, the above-described inventions have problems in that, although air corresponding to tens of times the amount of compressed air theoretically sprayed must be introduced together from the surroundings into the bag filter, air corresponding to only about four times to eight times the amount of compressed air is actually introduced together into the bag filter, and thus, a desired dust removing effect is not achieved.

Meanwhile, conventional dust collectors use a bag filter generally having a length of 5 m or less (a filter area of 2.45 m² or less), and also use a bag filter having a length of 5 m or more (a filter area of 2.45 m²) and, in some cases, a large bag filter having a length of 10 m, as such dust collectors become larger. Such conventional spraying devices as in the above-described inventions have a limitation, in particular, in that these large bag filters cannot have a sufficient dust removing effect.

In order for a large bag filter having a length of 10 m or more (a filter area of 4.9 m² or more) to have a strong dust removing force, the size of a spraying device must be increased. In this regard, in consideration of an interval between bag filters arranged in a dust collector, and the like, the increase in the size of a spraying device is very limited. Therefore, there is a need to develop a novel dust removal system having a stronger dust removing effect than that of conventional systems without increasing the size of a spraying device.

### RELATED ART DOCUMENTS

Korean Patent Application Publication No. 2001-0033657 (published on Apr. 25, 2001)

Korean Patent Application Publication No. 10-2009-0102977 (published on Oct. 1, 2009)

### DISCLOSURE

### Technical Problem

Therefore, the present invention has been made in view of the above problems, and it is one object of the present invention to provide a dust collector bag filter dust removal system that includes two control valves separated from each other and two compressed air pipes separated from each other to constitute an each independent compressed air supply member and supplies compressed air to each of a plurality of air amplifiers, an inside of which is partitioned, to be sprayed thereby, thus exhibiting a strong dust removing force when applied to a general bag filter having a length of 5 m or less (a filter area of 2.45 m² or less) as well as a large bag filter having a length of 10 m or more (a filter area of 4.9 m² or more).

### Technical Solution

In accordance with one aspect of the present invention, provided is a dust collector bag filter dust removal system including two control valves separated from each other and two compressed air pipes separated from each other and removing dust from a bag filter by instantaneously spraying amplified air from an upper portion of the bag filter, the system including: the compressed air pipes separated from each other and horizontally arranged in parallel to each other and provided, at upper or lower surfaces thereof, with a plurality of discharge holes spaced apart from each other through which compressed air is discharged; a plurality of air amplifiers, each including a body part having a donut shape with a central opening, a pair of connection holes formed at a lower or upper surface of the body part and coupled to the discharge holes to be supplied with the compressed air respectively from the two compressed air pipes, a spray slit formed in an inner circumferential surface of the body part to spray the compressed air supplied via the connection holes, and barrier ribs partitioning an inner space of the body part into two parts and having a curved shape so that the compressed air supplied via the connection holes is efficiently sprayed via the spray slit; an induction tube having a cylindrical shape and positioned below the air amplifier to spray amplified air drawing in ambient air into the bag filter when the compressed air is sprayed via the spray slit; and the control valve, first and second sides of which are connected to a compressed air supplier and the compressed air pipe, respectively, turning supply of the compressed air into the compressed air pipe from the compressed air supplier on or off.

In addition, the spray slit is formed along the inner circumferential surface of the body part to a circular shape and is formed as a space between a first guide formed on an upper side and a second guide formed on a lower side.

In addition, the induction tube extends from the second guide in an integrated form, and a Coand\check{a} surface having a curved shape is formed between the second guide and the induction tube.

In addition, the first guide is inclined downward so that the compressed air sprayed via the spray slit is sprayed lower than a horizontal surface.

In addition, the control valves operate each independently or simultaneously in an on/off state.

### Advantageous Effects

As apparent from the fore-going description, in a dust collector bag filter dust removal system according to the present invention, compressed air may be supplied into air amplifiers, inner spaces of which are partitioned by barrier ribs formed to a curved shape, each independently via two control valves separated from each other and two compressed air pipes separated from each other, thereby enhancing flow of the compressed air and maximizing a Coand\check{a} effect of the compressed air sprayed at a high speed via a spray slit.

In addition, by maximizing the Coand\check{a} effect, ambient air in an amount corresponding to tens of times that of air sprayed may be effectively sprayed into bag filters and thus, even when applied to a general bag filter having a length of 5 m or less (a filter area of 2.45 m² or less) as well as a large bag filter having a length of 10 m or more (a filter area of 4.9 m² or more), the dust collector bag filter dust removal system may exhibit a strong dust removing force.

Moreover, an inner space of each air amplifier is partitioned and thus the air amplifier serves as substantially two Coand\check{a} injectors, and compressed air is supplied into each injector via control valves and compressed air pipes that each independently operate. Thus, each of the control valves may operate to be independently or simultaneously in an on/off state and, even though any one of the control valves has a problem, the dust collector bag filter dust removal system may normally operate.

In particular, a dust collector has a risk of dust explosion or fire due to a characteristic thereof, while, in the dust collector bag filter dust removal system according to the present invention, two control valves and two compressed air pipes may each independently operate and thus compressed air is supplied into one of the two compressed air pipes and nitrogen for fire suppression or water is supplied to the other thereof, thereby preventing fire or explosion of bag filters or handling fire when it occurs and the like.

### DESCRIPTION OF DRAWINGS

The above and other objects, features and other advantages of the present invention will be more clearly understood from the following detailed description taken in conjunction with the accompanying drawings, in which:

FIG. 1 is a perspective view of a conventional compressed air spraying device for cleaning a bag filter;

FIG. 2 is a view of a dust collector to which a dust collector bag filter dust removal system is applied, according to an embodiment;

FIG. 3 is a plan view of a dust collector bag filter dust removal system according to the present invention;

FIG. 4 is a plan view illustrating structures of control valves and compressed air pipes according to the present invention;

FIG. 5 is a plan cross-sectional view illustrating structures of an air amplifier and compressed air pipes according to the present invention;

FIG. 6 is a lateral cross-sectional view illustrating structures of compressed air pipes, an air amplifier, and an induction tube according to the present invention; and

FIG. 7 is a partial enlarged view of portion ‘A’ (spraying slit) of FIG. 6.

### BEST MODE

Hereinafter, embodiments of the present invention will be described in detail with reference to the accompanying drawings in such a way that the invention may be easily carried out by one of ordinary skill in the art to which the present invention pertains. The present invention may be embodied in many different forms and should not be construed as being limited to the embodiments set forth herein. For clarity of description, elements irrelevant to description of the present invention are omitted, and like reference numerals denote like elements throughout the specification.

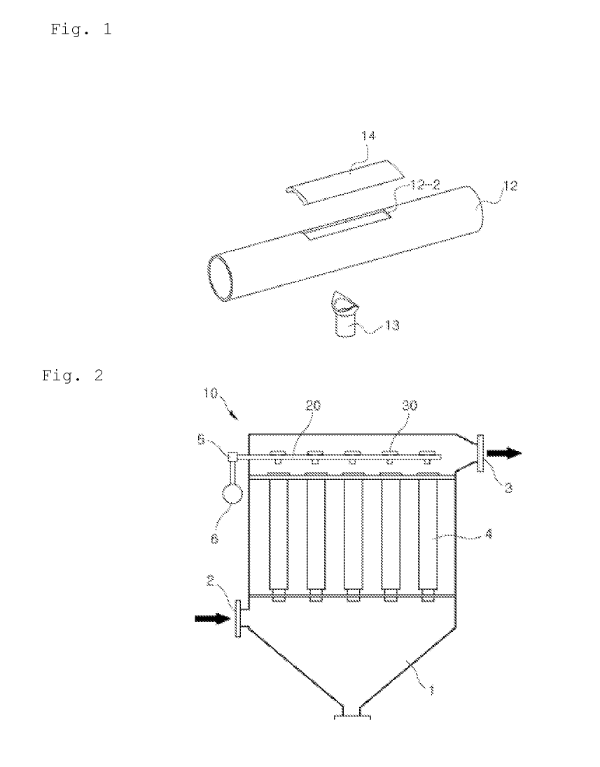

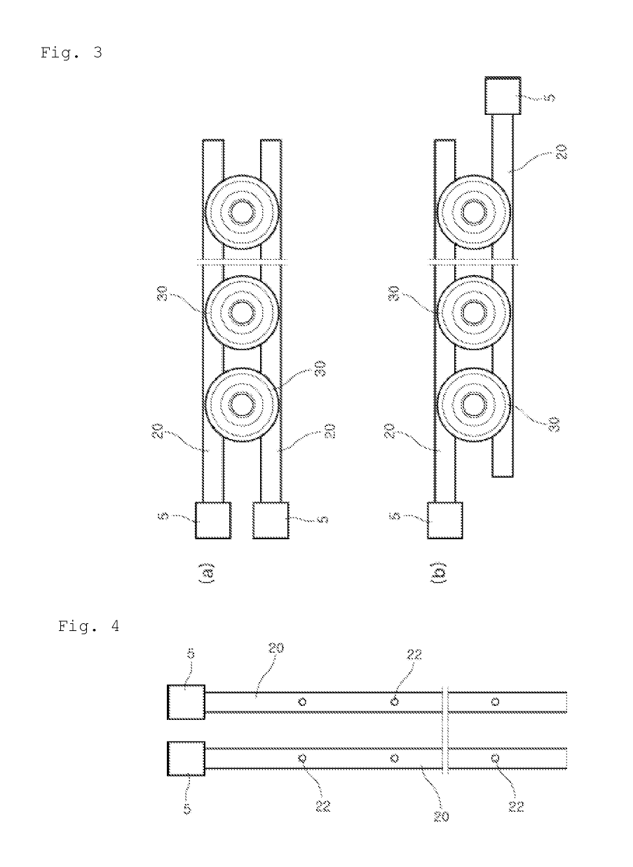

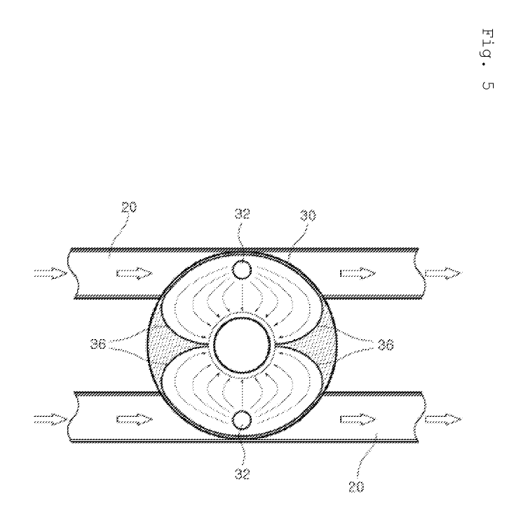

FIG. 2 is a view illustrating a general structure of a dust collector 10 to which a dust collector bag filter dust removal system is applied, according to an embodiment. FIG. 3 is a plan view of a dust collector bag filter dust removal system according to the present invention. FIG. 4 is a plan view illustrating structures of control valves and compressed air pipes according to the present invention.

As illustrated in FIGS. 2 to 4, the dust collector bag filter dust removal system according to the present invention includes: two compressed air pipes 20 separated from each other and horizontally arranged in parallel to each other; a plurality of air amplifiers 30 separated from each other at a constant interval and coupled to upper or lower surfaces of the compressed air pipes 20; induction tubes 40 extending downward between the two compressed air pipes 20 from the air amplifiers 30; a control valve 5 connected to one end of each compressed air pipe 20 to turn supply of compressed air into the compressed air pipe 20 on or off; and a compressed air supplier 6 connected to the control valve 5 to supply compressed air.

As illustrated in FIG. 3(a), the control valve 5 may be connected to one end of each compressed air pipe 20 on the same side as each other. Also, as illustrated in FIG. 3(b), the control valve 5 may be connected to one end of each compressed air pipe 20 on opposite sides to each other.

The compressed air pipe 20 is supplied with compressed air from the compressed air supplier 6 and transfers the compressed air to the air amplifiers 30 and is provided, at an upper or lower surface thereof, with a plurality of discharge holes through which the compressed air is discharged, spaced apart from each other at a constant interval.

The air amplifiers 30 are coupled, between the two compressed air pipes 20 arranged in parallel to each other, to upper portions thereof and are Coand\check{a} injectors that suck ambient air via between the compressed air pipes together with the compressed air and spray amplified air into bag filters 4.

The air amplifier 30 includes a body part 38 having a donut (ring) shape with a central opening, and the body part 38 is provided, in a lower or upper surface thereof, with a pair of connection holes 32, each of which is coupled to a discharge hole 22 formed in an upper or lower surface of each compressed air pipe 20, to be independently supplied with compressed air from the respective compressed air pipes 20.

For convenience of understanding in the present invention, the drawings illustrate that the discharge holes 22 are formed in the upper surface of each compressed air pipe 20, and the connection holes 32 respectively coupled to the discharge holes 22 are formed in the lower surface of the body part 38 of the air amplifier 30. However, the present invention is not limited to the above example and, if needed, the discharge holes 22 may be formed in the lower surface of each compressed air pipe 20, and the connection holes 32 respectively coupled to the discharge holes 22 may be formed in the upper surface of the body part 38 of the air amplifier 30.

The donut (ring)-shaped body part 30 is provided, at an inner circumferential surface thereof, with a spray slit 34 that sprays compressed air supplied via the connection holes 32, and the induction tube 40 extends from the body part 38 to a lower side of the compressed air pipe 20 so that, when compressed air is sprayed via the spray slit 34, amplified air drawing ambient air can be sprayed towards the bag filter 4.

As illustrated in FIG. 5, the body part 38 is provided, inside thereof, with barrier ribs 36 that equally divides an inner space into two parts.

When the barrier ribs 36 are not formed, the compressed air introduced via one connection hole 32 collides with the compressed air introduced via the other connection hole 32 inside the body part 38, thereby forming a vortex and, accordingly, spraying efficiency deteriorates. The barrier ribs 36 partitions the inside of the body part 38 into two completely independent spaces and thus fundamentally prevent collision of the compressed air introduced in a direction colliding with each other.

Meanwhile, when the barrier ribs 36 are formed in a substantially flat plate shape, a corner portion forming an acute angle may be formed in the inner space. In this case, a vortex may be formed at the corner portion and thus the barrier ribs 36 may have a curved shape so that rectangular corner portions are not formed in each partitioned inner space.

FIG. 5 illustrates an exemplary embodiment of the barrier ribs 36. The barrier ribs 36 may have a curved shape smoothly bent and extending in a direction from an outer circumferential surface to the inner circumferential surface of the donut (ring)-shaped body part 38 so that the partitioned inner spaces of the body part 38 have a substantially ellipsoidal shape.

When the inner space of the body part 38 is in such a form, compressed air supplied from each compressed air pipe 20 may naturally flow along inner curved surfaces of the body part 38 to be sprayed via the spray slit 34 at a high speed and, accordingly, amplification efficiency of the air amplifiers 30 is significantly enhanced.

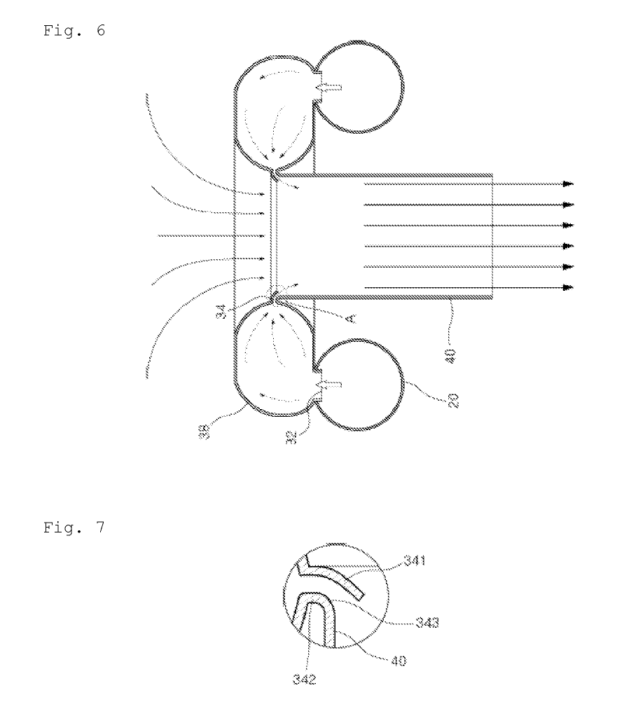

As illustrated in FIGS. 6 and 7, the spray slit 34 is formed along the inner circumferential surface of the body part 38 to a circular shape and is formed as a space between a first guide formed on an upper side and a second guide 342 formed on a lower side. Thus, a spray angle of the compressed air sprayed via the spray slit 34 may be adjusted by adjusting shapes of the first and second guides 341 and 342.

The induction tube 40 extends downward from the second guide 342 in an integrated form, and a Coand\check{a} surface 343 having a curved shape is formed between the second guide 342 and the induction tube 40.

The Coand\check{a} effect is a physical phenomenon in which a fluid ejected close to a surface of an object adheres to the surface of the object and flows quickly, thereby creating low-pressure distribution therearound.

That is, in a case in which a fluid is sprayed via a slit, when a curved surface is formed adjacent to the fluid in a spraying direction, the fluid curves along the curved surface and flows quickly.

According to the present invention, when the compressed air is sprayed via the spray slit 34 formed as the space between the first guide 341 and the second guide 342, the sprayed compressed air rapidly flows in a lower direction of the induction tube 40 along the Coand\check{a} surface 343 which is a curved surface formed between the second guide 342 and the induction tube 40, and ambient air drawn by the sprayed compressed air is accompanied thereby and the amplified air in an amount of tens of times that of the initially sprayed compressed air is instantaneously sprayed via the injection tube 40 into the bag filter 4 formed therebelow, thereby exhibiting a strong dust removing force.

The first guide 341 may be inclined downward such that the compressed air sprayed via the spray slit 34 can be sprayed lower than a horizontal surface.

When the first guide 341 is inclined downward at a certain angle, a larger amount of compressed air may be sprayed lower than a horizontal surface via the spray slit and, accordingly, the amount of the compressed air flowing along the Coand\check{a} surface 343 increases and thus the compressed air may efficiently draw in ambient air, thereby spraying a greater amount of amplified air into the bag filter 4 at a high speed.

The control valve 5 turns the supply of compressed air into the compressed air pipe 20 on or off and one side thereof is connected to the compressed air supplier 6 and the other side thereof is connected to the compressed air pipe 20.

In particular, the control valve 5 includes a controller and a valve and, when a signal is input to the controller from the outside, the controller turns the supply of the compressed air into the compressed air pipe 20 on or off by opening or closing the valve.

In the dust collector bag filter dust removal system according to the present invention, each of the two compressed air pipes 20 includes the control valve 5, and each control valve 5 may be independently in an on/off state or simultaneously in an on/off state.

As such, the dust collector bag filter dust removal system according to the present invention includes the two control valves 5 separated from each other, the two compressed air pipes 20 separated from each other, and the air amplifiers 30 each configured such that an inner space thereof is equally partitioned by the barrier ribs 36, thus serving as substantially two independent injectors, and each control valve 5 may be operated to be independently or simultaneously in an on/off state.

Thus, even when one of the control valves 5 has a problem, the dust removal system may normally operate, and compressed air is supplied into one of the two compressed air pipes 20 and nitrogen or water is supplied to the other thereof, thereby preventing fire or explosion of the bag filters or handling fire and the like.

In addition, the inside of the body part 38 of the air amplifier 30 is formed as two independent spaces by the barrier ribs 36 formed to a curved shape, and thus, the compressed air supplied from one compressed air pipe 20 does not collide with the compressed air from the other compressed air pipe 20 and naturally flows along the inner curved surfaces of the body part 38, thus being sprayed via the spray slit 34 at a high speed and, accordingly, the Coand\check{a} effect of the air amplifiers 30 may be maximized.

Moreover, due to maximization of the Coand\check{a} effect, ambient air in an amount of tens of times that of air sprayed via the spray slit 34 is effectively sprayed into the bag filters 4 together with the compressed air sprayed and thus, when applied to a general bag filter having a length of 5 m or less (a filter area of 2.45 m² or less) as well as a large bag filter having a length of 10 m or more (a filter area of 4.9 m² or more), the dust removal system according to the present invention may exhibit a strong dust removing force.

While some embodiments of the present invention have been described with reference to the accompanying drawings, it should be understood by those of ordinary skill in the art that changes may be made in the present embodiments without departing from the principles or teachings of the present invention. Thus, the present invention is not limited to the embodiments set forth herein, and various changes and modifications may be made without departing from the sprit and scope of the invention. In addition, such changes and modifications are within the scope of the present invention.

1. A dust collector bag filter dust removal system comprising two control valves separated from each other and two compressed air pipes separated from each other and removing dust from a bag filter by instantaneously spraying amplified air from an upper portion of the bag filter, the system comprising:
the compressed air pipes separated from each other and horizontally arranged in parallel to each other and provided, at upper or lower surfaces thereof, with a plurality of discharge holes spaced apart from each other through which compressed air is discharged;
a plurality of air amplifiers, each comprising:
a body part having a donut shape with a central opening;
a pair of connection holes formed at a lower or upper surface of the body part and coupled to the discharge holes to be supplied with the compressed air respectively from the two compressed air pipes;
a spray slit formed in an inner circumferential surface of the body part to spray the compressed air supplied via the connection holes; and
barrier ribs partitioning an inner space of the body part into two parts and having a curved shape so that the compressed air supplied via the connection holes is efficiently sprayed via the spray slit;
an induction tube having a cylindrical shape and positioned below the air amplifier to spray amplified air drawing in ambient air into the bag filter when the compressed air is sprayed via the spray slit; and
the control valve, first and second sides of which are connected to a compressed air supplier and the compressed air pipe, respectively, turning supply of the compressed air into the compressed air pipe from the compressed air supplier on or off.

2. The dust collector bag filter dust removal system of claim 1, wherein the spray slit is formed along the inner circumferential surface of the body part to a circular shape and is formed as a space between a first guide formed on an upper side and a second guide formed on a lower side.

3. The dust collector bag filter dust removal system of claim 2, wherein the induction tube extends from the second guide in an integrated form, and a Coand\check{a} surface having a curved shape is formed between the second guide and the induction tube.

4. The dust collector bag filter dust removal system of claim 2, wherein the first guide is inclined downward so that the compressed air sprayed via the spray slit is sprayed lower than a horizontal surface.

5. The dust collector bag filter dust removal system of claim 1, wherein the control valves operate each independently or simultaneously in an on/off state.
